(19) United States
(12) Patent Application Publication
(10) Pub. No.: US 2025/0206928 A1
(43) Pub. Date: Jun. 26, 2025

(54) POST-CONSUMER RECYCLATED COLORED POLYETHYLENE COMPOSITION, METHOD FOR ITS PREPARATION AND ARTICLES MADE THEREFROM

(71) Applicant: Borealis AG, Vienna (AT)

(72) Inventors: Tuan Anh Tran, Linz (AT); Andreas Nagl, Linz (AT); Doris Machl, Linz (AT); Yi Liu, Linz (AT); Peter Denifl, Linz (AT); Kilian Piettre, Linz (AT); Christian Goetzloff, Linz (AT); Michael Hettrich-Keller, Linz (AT); Sameer Vijay, Linz (AT); Hans-Jurgen Priesters, Schleiden-Wintzen (DE); Oliver Lambertz, Roesrath (DE)

(21) Appl. No.: 18/842,481

(22) PCT Filed: Mar. 20, 2023
(86) PCT No.: PCT/EP2023/057098

§ 371 Date: Aug. 29, 2024

(30) Foreign Application Priority Data
Mar. 22, 2022 (EP) 22163635.0
Nov. 18, 2022 (EP) 22208347.9

(51) Int. Cl. C08L 23/06; B29B 17/02; B29B 17/04; C08J 3/20

(52) U.S. Cl. CPC C08L 23/06; B29B 17/02; B29B 17/0412; C08J 3/201; B29B 2017/0224; B29B 2017/0279; B29B 2017/0289; B29K 2023/06; C08J 2323/06; C08L 2203/10; C08L 2205/025; C08L 2205/03; C08L 2207/20

(57) ABSTRACT

The present invention relates to polyethylene mixed color blend having (i) a melt flow rate (ISO1133, 5.0 kg; 190° C.) of 0.1 to 10 g/10 min, (ii) a density of 950 to 990 kg/m³ (ISO1183); (iii) a C2 fraction in amount of at least 95.0 wt.-%, as measured by 13C-NMR of the d2-tetrachloroethylene soluble fraction; (iv) a homopolymer fraction (HPF) content determined according to Chemical Composition Analysis by Cross Fractionation Chromatography (CFC) in the range from 73.0 to 91.0 wt.-%; (v) a copolymer fraction (CPF) content determined according to Chemical Composition Analysis Cross Fractionation Chromatography (CFC) in the range from 10.0 to 22.0 wt.-%; (vi) a total content of heavy metals selected from Cr, Cd, Hg and Pb of not more than 100 ppm with respect to the total polyethylene blend, as measured by x-ray fluorescence (XRF); and (vii) a Full Notch Creep Test (FNCT) determined according to ISO 16770-2019 at 50° C. and 6.0 MPa in 2 wt.-% Arkopal N100, of at least 3.0 h time to failure, wherein the polyethylene mixed color blend has a CIELAB color space (L*a*b*) measured according to DIN EN ISO 11664-4, as described herein, of L* from 30.0 to 73.0; a* from −10 to 25; and b* from −5 to 20. The invention further relates to a method of recycling a polyethylene mixed color material to obtain the above blend and to articles made from the above polyethylene mixed color blend.

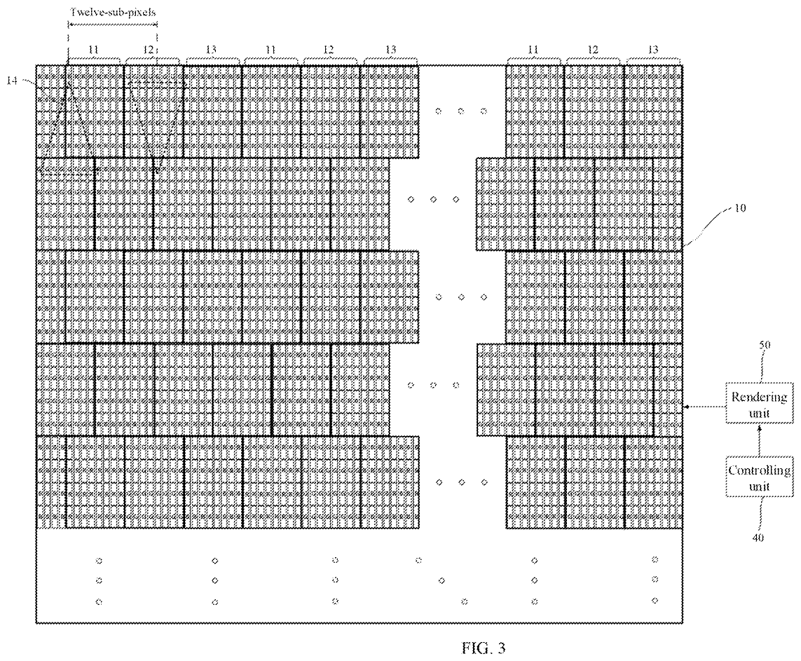

The present invention relates to mixed-color polyethylene blends originating from post-consumer recyclates (PCR).

### BACKGROUND OF THE INVENTION

The challenge of disposal of accumulated plastic waste and corresponding environmental issues have received widespread attention from the public and industry. Therefore, recycling of plastic material has become an important topic, where plastic waste can be turned into valuable resources for new plastic products. Hence, environmental and economic aspects can be combined in recycling and reusing plastic material.

Although recycling of plastic material has already begun in the mid-90s by implementing collection systems, which allow more target orientated collection and separation of plastic materials from other household waste materials, the reuse of plastic material originating from plastic waste is still limited. The so-called post-consumer recycled (PCR) plastic material generally contains mixtures of different plastics and several contaminant materials. Methods have been developed to further purify the post-consumer recycled (PCR) plastic material.

Many attempts have been made for purifying recycling streams as originating from post-consumer plastic waste. Among those measures washing, sieving, aeration, distillation and the like may be mentioned. For example, WO2018/046578 A1 discloses a process for the production of polyolefin recyclates from mixed color polyolefin waste including packaging waste comprising cold washing the waste with water followed by washing with an alkali medium at 60° C., followed by flake color sorting to receive color sorted mono polyolefin rich fractions.

U.S. Pat. No. 5,767,230 A describes a process comprising contacting PCR polyolefin chips containing volatile impurities with a heated gas at a superficial velocity sufficient to substantially reduce the volatile impurities such as odour active substances. However, up to now contamination by residual amounts of benzene turned out to be a problem. The origin of residual amounts of benzene in post-consumer recyclates is still dubious but constitutes a hurdle for end-uses in fields such as medical packaging, food packaging and the like. Residual amounts, i.e. traces of benzene constitute a particularly problem as odour tests by sniffing experiments become impossible. Thus, end-uses having certain demands as to the odour are blocked.

As yet a further problem known recyclates suffer from moderate homogeneity as reflected by surface contamination occurring in injection molded products.

Thus, there is still a strong need for recycled materials with properties as close as possible to virgin resins. In particular, it is the object of the present invention to provide PE-PCR materials, which are superior to existing materials in high purity of the product in terms of polyethylene content, low content of contaminants, brighter shade of grey color, high color consistency, high homogeneity, improved mechanical properties such as toughness performance, even at low temperature, good tensile and impact properties, and good processability.

### SUMMARY OF THE INVENTION

The objects underlying the present invention are to provide a post-consumer recycled polyethylene composition that addresses the above-described needs and disadvantages.

These objects are achieved by the provision of a post-consumer recycled polyethylene composition that addresses the above-described needs and disadvantages.

Accordingly, the present invention provides a polyethylene mixed color blend having
(i) a melt flow rate (ISO1133, 5.0 kg; 190° C.) of 0.1 to 10 g/10 min,
(ii) a density of 950 to 990 kg/m³ (ISO1183);
(iii) a C2 fraction in an amount of at least 95.0 wt.-%, as measured by 13C-NMR of the d2-tetrachloroethylene soluble fraction;
(iv) a homopolymer fraction (HPF) content determined according to Chemical Composition Analysis by Cross Fractionation Chromatography (CFC) in the range from 73.0 to 91.0 wt.-%; and
(v) a copolymer fraction (CPF) content determined according to Chemical Composition Analysis Cross Fractionation Chromatography (CFC) in the range from 10.0 to 22.0 wt.-%;
(vi) a total content of heavy metals selected from Cr, Cd, Hg and Pb of not more than 100 ppm with respect to the total polyethylene blend, as measured by x-ray fluorescence (XRF) as described herein; and
(vii) aFull Notch Creep Test environmental stress crack resistance (FNCT), determined according to 16770-2019, at 50° C. and 6.0 MPa in 2 wt.-% Arkopal N100, as described herein, of at least 3.0 h time to failure,
the polyethylene mixed color blend having a CIELAB color space (L*a*b*) measured according to DIN EN ISO 11664-4, as described herein, of
L* from 30.0 to 73.0;
a*from −10 to 25;
b* from −5 to 20.

The above objects are further achieved by a method of recycling a polyethylene mixed color material, comprising the steps of:
a) providing a mixed plastic waste stream (A);
b) sieving the mixed plastic waste stream (A) to create a sieved mixed plastic waste stream (B) having only articles with a longest dimension in the range from 30 to 400 mm;
c) sorting the sieved mixed plastic waste stream (B) by means of one or more sorting systems equipped with near infrared (NIR) and optical sensors, wherein the sieved mixed plastic waste stream (B) is at least sorted by polymer type and color, and optionally article form, thereby generating a sorted mixed-color polyethylene recycling stream (CM) that is subjected separately to steps d) and beyond;
d) shredding the sorted mixed-color polyethylene recycling stream (CM) to form a flaked mixed-color polyethylene recycling stream (D);
e) washing the flaked mixed-color polyethylene recycling stream (D) with a first aqueous washing solution (W1) without the input of thermal energy, thereby generating a first suspended polyethylene recycling stream (E);
f) removing at least a part of the first aqueous washing solution (W1) from the first suspended polyethylene recycling stream (E) to obtain a first washed polyethylene recycling stream (F);
g) washing the first washed polyethylene recycling stream (F) with a second aqueous washing solution (W2) thereby generating a second suspended polyethylene recycling stream (G), wherein sufficient thermal energy is introduced to the second suspended polyethylene recycling stream (G) to provide a temperature in the range from 65 to 95° C. during the washing;
h) removing the second aqueous washing solution (W2) and any material not floating on the surface of the second aqueous washing solution (W2) from the second suspended polyethylene recycling stream (G) to obtain a second washed polyethylene recycling stream (H);
i) i) drying the second washed polyethylene recycling stream (H), thereby obtaining a dried polyethylene recycling stream (I), which contains the polyethylene mixed color blend according to the invention.

The polyethylene mixed color blend according to the invention is obtainable or may be obtained according to the above method.

The present invention further provides an article made from the polyethylene mixed color blend of the invention or obtained according to the above method.

The present invention further provides the use of the polyethylene mixed color blend of the invention for packaging applications, for rotomolding applications, for automotive applications or for wire and cable applications.

### DETAILED DESCRIPTION OF THE INVENTION

For the purposes of the present description and of the subsequent claims, the term “recycling stream” is used to indicate a material processed from post-consumer waste as opposed to virgin polymers and/or materials. Post-consumer waste refers to objects having completed at least a first use cycle (or life cycle), i.e. having already served their first purpose. The term “virgin” denotes the newly produced materials and/or objects prior to their first use, which have not already been recycled. The term “recycled material” such as used herein denotes materials reprocessed from a post consumer waste or a recycling stream.

A blend denotes a mixture of two or more components, wherein at least one of the components is polymeric. In general, the blend can be prepared by mixing the two or more components. Suitable mixing procedures are known in the art. If such a blend includes a virgin material, said virgin material preferably is a polyethylene comprising at least 90 wt.-% of a reactor made polyethylene material, as well as optionally carbon black. A virgin material is a polymeric material which has not already been recycled.

For the purposes of the present description and of the subsequent claims, the term “polyethylene mixed color blend” indicates a polymer material including predominantly units derived from ethylene apart from other polymeric ingredients of arbitrary nature. Such other polymeric ingredients may for example originate from monomer units derived from alpha-olefins such as propylene, butylene, octene, and the like, styrene derivatives such as vinylstyrene, substituted and unsubstituted acrylates, substituted and unsubstituted methacrylates.

Said other polymeric materials can be identified in the polyethylene mixed color blend by means of quantitative ¹³C{1H}NMR measurements as described herein. In the quantitative ¹³C{1H}NMR measurement used herein and described below in the measurement methods different units in the polymeric chain can be distinguished and quantified. These units are ethylene units (C2 units), and units having 3, 4, 6 or 7 carbon atoms. Thereby, the units having 2 carbon atoms (C2 units) can be distinguished in the NMR spectrum as isolated C2 units and as continuous C2 units which indicate that the polymeric material contains an ethylene based polymer. The polyethylene mixed color blend according to the present invention usually includes low amounts of propylene-based polymeric components, particularly low amounts of units originating from isotactic polyethylene (iPP), which can be determined by ¹³C-NMR analysis of the soluble fraction, as described in the experimental section below.

The term “C2 fraction” denotes repetitive —[C₂H₄]— units derived from ethylene which are present in the linear chains backbone and the short chain branches as measured by quantitative ¹³C{¹H}NMR spectroscopy, whereby repetitive means at least two units.

The C2 fraction can be calculated as

$$\begin{matrix}{wt}_{C 2 fraction} = {fC}_{C 2 total} * 100 / ( {fC}_{C 2 total} + {fC}_{PP} ) \\ whereby \\ {fC}_{C 2 total} = ( Iddg - I two B 4 ) + ( I star B 1 * 6 ) + ( I star B 2 * 7 ) + ( I two B 4 * 9 ) + ( I three B 5 * 10 ) + ( ( I star B 4 plus - I two B 4 - I three B 5 ) * 7 ) + ( I 3 s * 3 ) \\ and \\ {fC}_{PP} = Isaa * 3\end{matrix}$$

Details are given in the experimental part below.

HDPE, LDPE or LLDPE, homo- and copolymer polyethylenes may be present in the recycling blends of the present invention. The polyethylenes may be characterized by analytical separation. An adequate method is Chemical Composition Analysis by Cross fractionation Chromatography (CFC). This method has been described and successfully implemented by Polymer Char, Valencia Technology Par, Gustave Eiffel 8, Paterna E-46980 Valencia, Spain. Chemical Composition Analysis by Cross Fractionation Chromatography (CFC) allows fractionation into a homopolymer fraction (HPF) and a copolymer fraction (CPF) and a potentially present iso-PP fraction (IPPF). The homopolymer fraction (HPF) is a fraction including polyethylenes similar to homopolymer-HDPE. The copolymer fraction (CPF) is a fraction similar to polyethylene HDPE copolymer but can also include fractions of LDPE respectively LLDPE. The iso-PP fraction (IPPF) includes isotactic polypropylene and is defined as the polymer fraction eluting at a temperature of 104° C. and above. The homopolymer fraction (HPF), the copolymer fraction (CPF) and the potentially present iso-PP fraction (IPPF) add up to 100 wt.-%. It is self-explaining the 100 wt.-% refer to the material being soluble within the Cross Fractionation Chromatography (CFC) experiment.

In addition to Chemical Composition Analysis by Cross Fractionation Chromatography (CFC), the polyethylene blend according to the present invention is also characterized by a C2 fraction in an amount of at least 95.0 wt.-%, preferably at least 97.0 wt.-% as measured by ¹³C-NMR of the d2-tetrachloroethylene soluble fraction. The percentage refers to the d2-tetrachloroethylene soluble part as used for the NMR experiment. The term “C2 fraction” equals the polymer fraction obtainable from ethylene monomer units, i.e. not from propylene monomer units.

The upper limit of the “C2 fraction” is 100 wt.-%.

Conventionally, further components such as fillers, including organic and inorganic fillers for example talc, chalk, carbon black, and further pigments such as TiO₂ as well as paper and cellulose may be present in the polyethylene mixed color blend of the invention.

The polyethylene mixed color blend according to the present invention typically has a melt flow rate (ISO1133, 5.0 kg; 190° C.) of 0.1 to 10 g/10 min. The melt flow rate can be influenced by splitting post-consumer plastic waste streams, for example, but not limited to: originating from extended producer's responsibility schemes, like from the German DSD, or sorted out of municipal solid waste into a high number of pre-sorted fractions and recombine them in an adequate way. Preferably, MFR₅ ranges from 0.5 to 5.0 g/10 min, more preferably from 0.7 to 4.0 g/10 min, and even more preferably from 1.0 to 3.0 g/10 min.

The polyethylene mixed color blend according to present invention has a density of from 950 to 990 kg/m³, preferably from 955 to 987 kg/m³, more preferably from 957 to 985 kg/m³, determined according to ISO1183.

The polyethylene blend according to the present invention has a C2 fraction in amount of at least 95.0 wt.-%, preferably at least 97.0 wt.-%, more preferably at least 98.0 wt.-%, as measured by ¹³C-NMR of the d2-tetrachloroethylene soluble fraction.

Usually the polyethylene blend according to the present invention is a recycled material.

Typically the recycling nature can be assessed by the presence of one or more of the following:
(1) inorganic residues content (measured by TGA) of above 0.1 wt.-%;
alternatively or in combination
(2) limonene as determined by using a static headspace sampler combined with a gas chromatograph and a mass spectrometer (HS-GC-MS) in an amount of 1 mg/m³ or higher;

It should be understood that option (2) is preferred.

It goes without saying that the amounts of inorganic residues, gels, and limonene should be as low as possible.

The polyethylene mixed color blend of the present invention has a homopolymer fraction (HPF) content determined according to Chemical Composition Analysis by Cross Fractionation Chromatography (CFC) in the range from 73.0 to 91.0 wt.-%, preferably in the range from 75.0 to 90.0 wt.-%, more preferably in the range from 77.0 to 89.0 wt.-%, even more preferably in the range from 79.0 to 88.0 wt.-%.

The polyethylene mixed color blend of the present invention further has a copolymer fraction (CPF) content determined according to Chemical Composition Analysis Cross Fractionation Chromatography (CFC) in the range from 10.0 to 22.0 wt.-%, preferably in the range from 12.0 to 22.0 wt.-%, more preferably in the range from 13.0 to 21.0 wt.-%, even more preferably in the range from 14.0 to 20.0 wt.-%.

The polyethylene mixed color blend of the present invention further has a total content of heavy metals selected from Cr, Cd, Hg and Pb of not more than 100 ppm, preferably of not more than 80 ppm, more preferably of not more than 50 ppm, with respect to the total polyethylene blend, as measured by x-ray fluorescence (XRF) as described in the experimental section below.

The polyethylene mixed color blend of the present invention further exhibits a Full Notch Creep Test environmental stress crack resistance (FNCT), determined according to ISO 16770-2019, at 50° C. and 6.0 MPa in 2 wt % Arkopal N100, as described in the experimental section below, of at least 3.0 h time to failure, preferably at least 3.5 h, more preferably at least 4.0 h, even more preferably at least 5.0 h time to failure.

The polyethylene mixed color blend of the present invention further has a CIELAB color space (L*a*b*) measured according to DIN EN ISO 11664-4, as described in the experimental section below, of
L* from 30.0 to 73.0;
a*from −10 to 25;
b* from −5 to 20.

Preferably, the CIELAB color space (L*a*b*) is defined by
L* from 32.0 to 71.0;
a* from −9 to 23;
b*from −5 to 18.

More preferably, the CIELAB color space (L*a*b*) is defined by
L* from 35.0 to 70.0;
a* from −7 to 20;
b* from −5 to 15.

The polyethylene mixed color blend of the present invention is characterized by a higher chemical purity that conventional recycled materials, particularly lower contents of C3 units (propylene units), such as isotactic polypropylene (iPP). Preferably, the polyethylene mixed color blend according to the present invention contains units originating from isotactic polypropylene (iPP) in an amount of not more than from 0.1 to 3.0 wt. %, preferably from 0.1 to 2.5 wt. %, more preferably from 0.2 to 2.0 wt. %, determined by ¹³C-NMR analysis of the soluble fraction, as described in the experimental section below.

The polyethylene mixed color blend according to the present invention preferably has a Large Amplitude Oscillatory Shear-Non-Linear Factor (LAOS-NLF), determined at 190° C., an angular frequency of 0.628 rad/s and a strain of 1000%, as described in the experimental section below, in the range of 2.0 to 4.0.

LAOS-NLF is a rheological measure of the long chain branching content defined as

$$LAOS - NLF = \vert \frac{{G}_{1}^{′}}{{G}_{3}^{′}} \vert$$

whereby
G₁′ is the first order Fourier Coefficient
G₃′ is the third order Fourier Coefficent

The LAOS-NLF further indicates non-linear polymer structure. A higher value of LAOS-NLF indicates a higher content of long chain branching.

The polyethylene mixed color blend according to according to the present invention preferably has a shear thinning factor (STF) value, defined as the ratio of the complex viscosities eta(0.05) and eta(300) at 190° C. within a frequency range of from 0.01 and 600 rad/s according to ISO 6721-1 and 6721-10, determined as described in the experimental section below, in the range of from 30 to 60, more preferably in the range of from 32 to 57, even more preferably in the range of from 33 to 55. The shear thinning factor (STF) indicates the processability of the polyethylene material.

The polyethylene mixed color blend according to the present invention preferably has a benzene content below the detection limit, determined according to static headspace chromatography mass spectroscopy (HS/GC-MS) at 100° C./2 h, as described in the experimental section below.

The polyethylene mixed color blend according to the present invention preferably has an odour (VDA270-B3) of 5.0 or lower, more preferably 4.0 or lower. It should be understood that many commercial recycling grades which do not report odour are in fact even worse, as an odour test according to VDA270 is forbidden due to the presence of problematic substances.

The polyethylene mixed color blend according to according to the present invention preferably has a Charpy notched impact strength, determined according to ISO 179-1 eA at −20° C. on injection moulded specimens of 80×10×4 mm prepared according to EN ISO 1873-2, of at least 5.0 kJ/m², more preferably at least 5.5 kJ/m², even more preferably at least 6.0 kJ/m².

The polyethylene mixed color blend according to the present invention preferably has a tensile modulus, measured according to ISO 527-2 and as described in the experimental section below, in the range of 600 to 1300 MPa, more preferably in the range of 700 to 1200 MPa.

The polyethylene mixed color blend according to the present invention preferably has a flexural modulus, measured according to ISO 178 and as described in the experimental section below, in the range of 600 to 1300 MPa, more preferably in the range of 700 to 1100 MPa.

The polyethylene mixed color blend according to according to the present invention preferably has an impact strength in a 11 bottle drop test at 0° C., determined as described in the experimental section below, of at least 3.0 m, more preferably at least 3.5 m, even more preferably at least 4.0 m average drop height, wherein the bottles were produced as also described in the experimental section below.

The polyethylene mixed color blend according to the present invention is preferably obtained from post-consumer recyclates (PCR), preferably 100% PCR materials. Such PCR materials are typically obtained from consumer waste streams, such as waste streams originating from conventional collecting systems such as those implemented in the European Union (e.g. extended producer responsibility schemes, EPR schemes). PCR materials may also be derived from municipal solid waste originating outside of EPR collection systems.

The feedstock materials for obtaining the polyethylene mixed color blend according to the present invention may be selected from a wide range of fractions generated from municipal solid waste (MSW, also often referred to as residual waste, black bin waste) to Extended Producer Responsibility (EPR)-based feedstocks, for example the ARA 402 fraction from Altstoff Recycling Austria or the DSD 329 fraction from German Producer Responsibility Organisations, such as DSD—Duales System Holding, Interzero, Reclay.

It is preferred that the polyethylene mixed color blend according to the present invention comprises at least 95.0 wt.-%, more preferably at least 96 wt.-%, even more preferably at least 97 wt.-% originating from post-consumer waste.

The above objects can also be achieved by the above-described method of recycling a polyethylene mixed color material, comprising the steps a) to i). In other words, the polyethylene mixed color blend according to the present invention is preferably obtainable or is obtained by the above-described method or the preferred methods described below.

According to step c), the sieved mixed plastic waste stream (B) may preferably be further sorted by article form. In this case artificial intelligence sorting systems (which are commercially available e.g. from Tomra Systems) may be used to sort also according to application type (MFR) or specific objects. In sorting step c) preferably white and natural waste materials are sorted out so that substantially only waste materials of non-white and/or non-natural colors remain in the one or more sorted mixed color polyethylene recycling stream (s) (CM).

By sorting step c) preferably one or more sorted mixed color polyethylene recycling stream (s) (CM) is generated. This can preferably be achieved by removing white and natural polyethylene objects and non-polyethylene objects. In this context “natural” signifies that the objects are of natural color. This means that essentially no pigments (including carbon black) or colorants such as dyes or inks are included in the objects. On the other hand, “white” signifies that white pigments are included in the objects. The same logic applies to the sorting of flakes as described in step k) below. The term “mixed color” means that a given material encompasses all colors except that white and natural colors have been intentionally removed as far as possible.

In step f), preferably substantially all of the first aqueous washing solution (W1) is removed from the first suspended polyethylene polyolefin recycling stream (E) to obtain said first washed polyethylene recycling stream (F).

In step h) the removal of the second aqueous washing solution (W2) and any material not floating on the surface of the second aqueous washing solution is preferably achieved by a density separation step.

The method of the present invention may further comprise at least one of the following steps:
j) separating the dried polyethylene recycling stream (I) obtained from step i) into a light fraction and a heavy fraction polyethylene recycling stream (J);
k) further sorting the heavy fraction polyethylene recycling stream (J) or, in the case that step j) is absent, the dried polyethylene recycling stream (I) by means of one or more optical sorters with NIR and/or optical sensors sorting for one or more target polyethylene by removing any flakes containing material other than the one or more target polyethylene(s) or of flakes of undesired color (e.g black etc.), yielding a purified polyethylene recycling stream (K);
l) melt extruding, preferably pelletizing, the purified polyethylene recycling stream (K), preferably wherein additives (Ad) are added in the melt state, to form an extruded, preferably pelletized, recycled polyethylene product (L);
m) aerating the recycled polyethylene product (L) or, in the case that step l) is absent, the purified polyethylene recycling stream (K) to remove volatile organic compounds, thereby generating an aerated recycled polyethylene product (M), being either an aerated extruded, preferably pelletized, recycled polyethylene product (M1) or aerated recycled polyethylene flakes (M2),
wherein the order of steps l) and m) can be interchanged, such that the purified polyethylene recycling stream (K) is first aerated to form aerated recycled polyethylene flakes (M2) that are subsequently extruded, preferably wherein additives (Ad) are added in the melt state, to form an extruded, preferably pelletized, aerated recycled polyethylene product (M3), which is the polyethylene mixed color blend according to the present invention.

In step j) the separation may preferably be done by a windsifter. The separation may alternatively be done based on the aerodynamic properties of the particles (such as flakes, e.g. separating thin light flexible flakes from heavy thick rigid flakes.

After the above step j) a screening step j1) may be conducted, wherein the dried polyethylene recycling stream (I) is sieved to remove the fines, generating a sieved polyethylene recycling stream (J1), which may subsequently be subjected to optional step k) described above. In this screening step j1) fines of dimensions, preferably having a size of 2.5 mm or below are removed.

The present invention is further directed to an article made from the polyethylene mixed color blend as described above. It is preferred that the polyethylene blend according to the present invention amounts to at least 85 wt. %, more preferably at least 90 wt.-%, even more preferably at least 93 wt.-% of the total composition for making the article. Residual components may include additives such as antioxidants, stabilizers, carbon black, optionally in the form of a masterbatch, pigments, colorants such as dyes or inks.

The article is preferably a bottle or an article for other packaging applications. The blend of the invention may also be used for rotomolding applications, for automotive applications or for wire and cable applications. In a preferred aspect, the polyethylene blend according to the present invention amounts to a range from 95 wt.-% to 98 wt.-% of the total composition for making the article. Preferably the article is made from the polyethylene blend according to the present invention and additives only. Additives may preferably be selected from the group consisting of UV-stabilizers, antioxidants and/or acid scavengers.

The polyethylene mixed color blend of the present invention may also be blended with at least one virgin polyolefin and/or recycled polyolefin. For example, virgin ethylene homopolymer or copolymers can be blended.

### Measurement Methods

The following definitions of terms and determination methods apply to the above general description of the invention as well as to the below examples, unless otherwise defined.

### a) Melt Flow Rate

The melt flow rate (MFR) was determined according to ISO 1133 and is indicated in g/10 min. The MFR is an indication of the flowability and hence the processability of the polymer. The higher the melt flow rate, the lower the viscosity of the polymer. Here, the MFR was determined at a temperature of 190° C. and under a load of 2.16 kg, 5.0 kg or 21.6 kg.

### b) Density

The density was determined according to ISO 1183-1.

### C) C2 Fraction by NMR Spectroscopy and General Microstructure Including “Continuous C3” as Well as Short Chain Branches

Quantitative ¹³C{¹H}NMR spectra were recorded in the solution-state using a Bruker AVNEO 400 MHz NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. Standard single-pulse excitation was employed without NOE, using an optimised tip angle, 1 s recycle delay and a bi-level WALTZ16 decoupling scheme {zhou07,busico07}. A total of 6144 (6k) transients were acquired per spectra.

Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polyethylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3s 32.2 ppm) were observed. If one or the other structural element is not observable it is excluded from the equations. The intensity of the combined ethylene backbone methine carbons (ddg) containing the polyethylene backbone carbons (dd 30.0 ppm), γ-carbons (g 29.6 ppm) the 4s and the threeB4 carbon (to be compensated for later on) is taken between 30.9 ppm and 29.3 ppm excluding the Tββ from polyethylene. The amount of C2 related carbons was quantified using all mentioned signals according to the following equation:

$${fC}_{C 2 total} = ( Iddg - I two B 4 ) + ( I star B 1 * 6 ) + ( I star B 2 * 7 ) + ( I two B 4 * 9 ) + ( I three B 5 * 10 ) + ( ( I star B 4 plus - I two B 4 - I three B 5 ) * 7 ) + ( I 3 s * 3 )$$

When characteristic signals corresponding to the presence of polyethylene (PP, continuous C3) were observed at 46.7 ppm, 29.0 ppm and 22.0 ppm the amount of PP related carbons was quantified using the integral of Sαα at 46.6 ppm:

$${fC}_{PP} = Is aa * 3$$

The weight percent of the C2 fraction and the polyethylene can be quantified according following equations:

$$\begin{matrix}{wt}_{C 2 fraction} = {fC}_{C 2 total} * 100 / ( {fC}_{C 2 total} + {fC}_{PP} ) \\ {wt}_{PP} = {fC}_{PP} * 100 / ( {fC}_{C 2 total} + {fC}_{PP} )\end{matrix}$$

Characteristic signals corresponding to various short chain branches were observed and their weight percentages quantified as the related branch would be an alpha-olefin, starting by quantifying the weight fraction of each:

$$\begin{matrix}fwtC 2 = {fC}_{C 2 total} - ( I star B 1 * 3 ) - ( I star B 2 * 4 ) - ( I two B 4 * 6 ) - ( I three B 5 * 7 ) \\ fwtC 3 ( isolated C 3 ) = I star B 1 * 3 \\ fwtC 4 = I star B 2 * 4 \\ fwtC 6 = I two B 4 * 6 \\ fwtC 7 = I three B 5 * 7\end{matrix}$$

Normalisation of all weight fractions leads to the amount of weight percent for all related branches:

$$\begin{matrix}{f sum}_{wt \% total} = fwtC 2 + fwtC 3 + fwtC 4 + fwtC 6 + fwtC 7 + {fC}_{PP} \\ wtC 2 total = fwtC 2 * 100 / {f sum}_{wt \% total} \\ wtC 3 total = fwtC 3 * 100 / {f sum}_{wt \% total} \\ wtC 4 total = fwtC 4 * 100 / {f sum}_{wt \% total} \\ wtC 5 total = fwtC 5 * 100 / {f sum}_{wt \% total} \\ wtC 6 total = fwtC 6 * 100 / {f sum}_{wt \% total}\end{matrix}$$

zhou07
Zhou, Z., Kuemmerle, R., Qiu, X., Redwine, D., Cong, R., Taha, A., Baugh, D. Winniford, B., J. Mag. Reson. 187 (2007) 225
   busico07
Busico, V., Carbonniere, P., Cipullo, R., Pellecchia, R., Severn, J., Talarico, G., Macromol. Rapid Commun. 2007, 28, 1128
   singh09
Singh, G., Kothari, A., Gupta, V., Polymer Testing 28 5 (2009), 475
   randall89
J. Randall, Macromol. Sci., Rev. Macromol. Chem. Phys. 1989, C29, 201.
   brandolini00
A. J. Brandolini, D. D. Hills, NMR Spectra of Polymers and Polymer Additives, Marcel Dekker Inc., 2000c) Crystex analysis, crystalline fraction (CF) and soluble fraction (SF)

### d) Cross Fractionation Chromatography

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four band IR5 infrared detector (PolymerChar, Valencia, Spain) was used to monitor the concentration. The polymer was dissolved at 160° C. for 150 minutes at a concentration of around 1 mg/ml.

To avoid injecting possible gels and polymers, which do not dissolve in TCB at 160° C., like PET and PA, the weighed out sample was packed into stainless steel mesh MW 0,077/D 0.05 mmm.

Once the sample was completely dissolved an aliquot of 0.5 ml was loaded into the TREF column and stabilized for a while at 110° C. The polymer was crystallized and precipitate to a temperature of 30° C. by applying a constant cooling rate of 0.1° C./min. A discontinuous elution process is performed using the following temperature steps: (35, 40, 50, 55, 60, 65, 70, 75, 80, 85, 90, 95, 100, 103, 106, 109, 112, 115, 117, 119, 121, 123, 125, 127, 130, 135 and 140).

In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PP molecular weight equivalents.

$$\begin{matrix}{K}_{PS} = 19 \times {10}^{- 3} mL / g , & {α}_{PS} = 0.655 \\ {K}_{PP} = 19 \times {10}^{- 3} mL / g , & {α}_{PP} = 0.725\end{matrix}$$

A third order polynomial fit was used to fit the calibration data. Data processing was performed using the software provided from PolymerChar with the CFC instrument.

### e) Environmental Stress Cracking Resistance (FNCT)

The Environmental Stress Cracking Resistance is assessed by full notch creep test (FNCT). FNCT time to failure was measured according to the full notch creep test method (FNCT) ISO 16770-2019 at 50° C. with a notch depth of 1 mm and specimen dimensions 6 mm×6 mm×90 mm (4 mm×4 mm). The solvent used was 2 wt % Arkopal N100 in deionized water. The sample preparation was done following ISO 16670-2019 (compression moulding and annealing).

The test specimens were stressed in an aqueous solution at 6.0 MPa stress. For each sample, 3 to 4 specimens were tested. The average time to failure value of all the measurements were used to report the time to failure in hours.

### f) Bottle Drop Test

1 L bottles, having an outer diameter of 90 mm, a wall thickness of 0.6 mm, an overall-height of 204 mm and a height of the cylindrical mantle of 185 mm were produced by extrusion blow moulding on a B&W machine with a single screw extruder using a melt temperature of 190° C. and a mould temperature of 15° C., as described in WO 2020/148319 A1.

A progressive drop test was performed as described in WO 2020/148319 A1. Each bottle as defined above is dropped several times in a row from increasing heights. The test is stopped for each bottle when fracture occurs.

The drop test is performed on the extrusion blow moulded 1 L bottles as described above. The bottles are filled up to their shoulder with water.

For each test series at least 12 bottles are required. 4 bottles are dropped simultaneously from a starting height which is chosen according to the following table, where the expected fracture drop height has been determined in pre-tests or has been chosen from experience:

| | | | |
|---|---|---|---|
| Expected fracture drop height (m) | 0.3-1-0 | 1.0-2.5 | 2.5-5.0 |
| Starting drop height (m) | 0.2 | 0.5 | 2.0 |

Those bottles that show fracture are discarded and the test is continued with the remaining bottles at increasing heights. The size of the steps by which the height is increased depends on the starting height. Below a starting height of 0.5 m, the step size is 0.1 m while equal to or above 0.5 m, the step size is 0.25 m. The fracture drop height is noted for each bottle and from the single values, the average fracture drop height is calculated according to the following formula:

$${h}_{p} = \sum ( {h}_{i} ) / {n}_{g}$$

wherein
hₚ=average fracture drop height
hᵢ=individual fracture drop height
n_{g}=total number of dropped containers

### g) Tensile Modulus and Tensile Strain at Break

Tensile modulus and tensile strain at break were measured according to ISO 527-2 (cross head speed=1 mm/min; test speed 50 mm/min at 23° C.) using injection molded specimens as described in EN ISO 1873-2 (dog bone shape, 4 mm thickness). The measurement is done after 96 h conditioning time of the specimen.

### h) Flexural Modulus

The flexural modulus was determined according to ISO 178 method A (3-point bending test) on 80 mm×10 mm×4 mm. Following the standard, a test speed of 2 mm/min and a span length of 16×thickness was used. The testing temperature was 23±2° C. Injection moulding was carried out according to ISO 17855-2.

### i) Impact Strength (Charpy NIS)

Impact strength was determined as notched Charpy impact strength (1eA) (non-instrumented, ISO 179-1 at 0° C.) according to ISO 179-1 eA at +23° C. and −20° C. on injection moulded specimens of 80×10×4 mm prepared according to EN ISO 1873-2.

### j) CIELAB Color Space (L*a*b*)

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A.

### k) Heavy Metal Content

The content of heavy metals including Cr, Cd, Hg, and Pb was determined by x ray fluorescence (XRF).

The instrument used for the XRF measurements was a wavelength dispersive Zetium (2.4 kW) from Malvern Panalytical. The instrument was calibrated with polyolefin based standard sets from Malvern Panalytical i.e. Toxel.

The analysis are done under vacuum on a plaque with a diameter of 40 mm and a thickness of 2 mm.

The method is used to determine the quantitative content of Cr, Cd, Hg and Pb in polyolefin matrix within defined ranges of this standard.

### l) Headspace Gas Chromatography/Mass Spectroscopy (HS-GC-MS)

The determination of benzene and limonene is based on a static headspace (HS) approach. This analysis uses a combination of a HS sampler with a gas chromatograph (GC) and a mass spectrometer (MS) for screening purposes.

Samples were delivered to the lab in sealed aluminum-coated polyethylene (PE) bags. Prior to the analysis, samples were cryo-milled, a portion of 2.000±0.100 g was weighed in a 20 ml HS vial and tightly closed. For every sample, a double determination was performed.

### 1.1HS/GC/MS Parameters

HS parameters (Agilent G1888 Headspace Sampler)

| | |
|---|---|
| Vial equilibration time: | 120 min (sample), 5 min (standard) |
| Oven temperature: | 100° C. (sample), 200° C. (standard) |
| Loop temperature: | 110° C. (sample), 205° C. (standard) |
| Transfer line temperature: | 120° C. (sample), 210° C. (standard) |
| Low shaking | |

GC parameters (Agilent 7890A GC System)

| | |
|---|---|
| Column: | ZB-WAX 7HG-G007-22 (30 m × 250 μm × 1 μm) |
| Carrier gas: | Helium 5.0 |
| Flow: | 2 ml/min |
| Split: | 5:1 |
| GC oven program: | 35° C. for 0.1 min |
| | 10° C./min until 250° C. |
| | 250° C. for 1 min |

MS parameters (Agilent 5975C inert XL MSD)

| Acquisition mode: | Scan |
|---|---|
| Scan parameters: | |
| Low mass: | 20 |
| High mass: | 200 |
| Threshold: | 10 |

### Software/Data Evaluation

MSD ChemStation E.02.02.1431
MassHunter GC/MS Acquisition B.07.05.2479
AMDIS GC/MS Analysis Version 2.71
NIST/EPA/NIH Mass Spectral Library (2011 version)
NIST Mass Spectral Search Program Version 2.0 g

AMDIS deconvolution parameters

| | |
|---|---|
| Minimum match factor: | 80 |
| Threshold: | Low |
| Scan direction: | High to Low |
| Data file format: | Agilent files |
| Instrument type: | Quadrupole |
| Component width: | 20 |
| Adjacent peak subtraction: | Two |
| Resolution: | High |
| Sensitivity: | Very high |
| Shape requirements: | Medium |
| Solvent tailing: | 91 m/z |
| Column bleed: | 207 m/z |
| Min. model peaks: | 2 |
| Min. S/N: | 10 |
| Min. certain peaks: | 0.5 |

MSD ChemStation integration parameters

| Integrator: | ChemStation |
|---|---|
| Initial area reject: | 0 |
| Initial peak width: | 0.005 |
| Shoulder detection: | off |
| Initial threshold: | 10.5 |

In this study, the statement “below the limit of detection (<LOD)” describes a condition where either the match factor is below 80 (AMDIS) or the signal to noise ratio (Pk-pk S/N=Corrected signal/Pk-pk noise, MSD ChemStation signal to noise report) of the peak in the sample run is below 3. The results refer solely to the measured samples, time of measurement and the applied parameters.

### 1.2. Standard Solutions

For a positive identification and comparison with the (lowest) odour detection thresholds (ODT), a benzene standard and a limonene standard were used, respectively (see Table 1).

For the HS/GC/MS analysis, 5 μl of the respective standard were injected in a 20 ml HS vial, tightly closed and measured.

Assuming full vaporisation of the standard substance, the concentration of benzene (or in the other case limonene) in the HS CG was estimated as listed in Table 1.

TABLE 1
Calibration standard and ODT

| | | c_{G}/ | Target | (lowest) ODT/ |
|---|---|---|---|---|
| Analyte | Solvent | mg m⁻³ | ion (m/z) | mg m⁻³ [1] |
| Benzene | Methanol | 25 | 78 | 1.5 |
| Limonene | 2-Butanol | 75 | 68 | 0.21 |

### 1.3 Data Evaluation

The concentration of an analyte in the HS c_{G} is calculated by considering the substance amount m_{G} and the available HS volume V_{G} (Equation 1).

$${c}_{G}^{Standard} [ mg / {m}^{3} ] = \frac{{m}_{G}^{Standard}}{{V}_{G}^{Standard}} \qquad Equation 1$$

To estimate the concentration of an analyte in the HS above a polymer sample, the response factor, Rf of a one-point calibration is required (Equation 2). By integrating the extracted ion chromatogram (EIC), the peak area is obtained for the analyte.

The corresponding target ion is listed in

$$Rf = \frac{{c}_{G}^{Standard}}{Peak {area}^{standard}} \qquad Equation 2$$

The concentration of an analyte in the HS above a polymer sample, c_{G}^{Sample} is calculated by multiplying the response factor with the EIC peak area of the sample (Equation 3).

$${c}_{G}^{Standard} [ mg / {m}^{3} ] = Rf * Peak {area}^{Sample} \qquad Equation 3$$

Additionally, the odour relevance of an analyte in the HS above a polymer sample is estimated by the odour activity value (OAV). Therefore, the concentration of an analyte in the HS above a polymer sample c_{G}^{Sample} is compared with the (lowest) odour detection threshold (ODT) found in literature (Equation 4) [1]. A value above 1 indicates the relevance of an analyte to the odour at the given HS temperature.

$$OAV = \frac{{c}_{G}^{Sample} [ mg / {m}^{3} ]}{ODT [ mg / {m}^{3} ]} \qquad Equation 4$$

### 1.4 Considerations and Limitations

It must be considered that the ODT for some substances is below the detection limit (LOD) of the method. Therefore, components below the LOD might be missed although still relevant to the overall odour.

The OAV is based on the assumption that the HS parameters are somewhat relatable to the measurement conditions of an ODT determination. Of course, this is not fully applicable because temperature settings of 100° C. are not necessarily chosen for such experiments and have therefore limited practical value. Nevertheless, this approach can at least indicate the odour relevance of the defined marker substances.

Considering all the mentioned assumptions and limitations, the determined concentrations in the HS above the sample and odour activity values must be taken as rough estimates only.

### 1.5 References

[1] Van Gemert L. J., Odour Thresholds: Compilations of odour threshold values in air, water and other media, Utrecht, Oliemans Punter & Partners BV, 2011.

### n) Odour (VDA270-B3)

VDA 270 is a determination of the odour characteristics of trim materials in motor vehicles. In this study, the odour is determined following VDA 270 (2018) variant B3. The odour of the respective sample is evaluated by each assessor according to the VDA 270 scale after lifting the jar's lid as little as possible. The hexamerous scale consists of the following grades: Grade 1: not perceptible, Grade 2: perceptible, not disturbing, Grade 3: clearly perceptible, but not disturbing, Grade 4: disturbing, Grade 5: strongly disturbing, Grade 6: not acceptable. Assessors stay calm during the assessment and are not allowed to bias each other by discussing individual results during the test. They are not allowed to adjust their assessment after testing another sample, either. For statistical reasons (and as accepted by the VDA 270) assessors are forced to use whole steps in their evaluation. Consequently, the odour grade is based on the average mean of all individual assessments, and rounded to whole numbers.

### o) Dynamic Rheological Measurements

The characterisation of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. and 200° C. for PE and PP respectively applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$( t ) = {γ}_{0} sin ( ω t ) \qquad ( 1 )$$

If the applied strain is within the linear viscoelastic regime, the resulting sinusoidal stress response can be given by

$$( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time.

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{′} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa . s ] \qquad ( 6 )$$

$${η}^{′} = \frac{{G}^{″}}{ω} [ Pa . s ] \qquad ( 7 )$$

$${η}^{″} = \frac{{G}^{′}}{ω} [ Pa . s ] \qquad ( 8 )$$

The determination of so-called Shear Thinning Factor (STF) is done, as described in equation 9.

$$STF = \frac{Eta * for ( ω = 0.05 rad / s )}{Eta * for ( ω = 300 rad / s )} \vert \qquad ( 9 )$$

The values are determined by means of a single point interpolation procedure, as defined by Rheoplus software. In situations for which a given G* value is not experimentally reached, the value is 10 determined by means of an extrapolation, using the same procedure as before. In both cases (interpolation or extrapolation), the option from Rheoplus “—Interpolate y-values to x-values from parameter” and the “logarithmic interpolation type” were applied.

These tests were done on compression molded discs done with cryomilled powder.

### p) LAOS Non-Linear Viscoelastic Ratio

The investigation of the non-linear viscoelastic behavior under shear flow was done resorting to Large Amplitude Oscillatory Shear. The method requires the application of a sinusoidal strain amplitude, γ0, imposed at a given angular frequency, ω, for a given time, t. Provided that the applied sinusoidal strain is high enough, a non-linear response is generated. The stress, σ is in this case a 20 function of the applied strain amplitude, time and the angular frequency. Under these conditions, the non-linear stress response is still a periodic function; however, it can no longer be expressed by a single harmonic sinusoid. The stress resulting from a non-linear viscoelastic response [0-0] can be expressed by a Fourier series, which includes the higher harmonics contributions:

$$σ ( t , ω , {γ}_{0} ) = {γ}_{0} \cdot {\sum }_{n} [ {G}_{n}^{′} ( ω , {γ}_{0} ) \cdot sin ( n ω t ) + {G}_{n}^{″} ( ω , {y}_{0} ) \cdot cos ( n ω t ) ]$$

with, σ—stress response
t—time
ω—frequency
γ0—strain amplitude
n—harmonic number
G′ₙ—n order elastic Fourier coefficient
G″ₙ—n order viscous Fourier coefficient

The non-linear viscoelastic response was analysed applying Large Amplitude Oscillatory Shear (LAOS) [4-6]. Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a temperature of 190° C., an angular frequency of 0.628 rad/s and a strain of 1000%. In order to ensure that steady state conditions are reached, the non-linear response is only determined after at least 20 cycles per measurement are completed. The Large Amplitude Oscillatory Shear Non-Linear Factor (LAOS_NLF) is defined by:

$${LAOS}_{NLF} ( 1000 \% ) = \vert \frac{{G}_{1}^{′}}{{G}_{3}^{′}} \vert$$

where G′1—first order Fourier Coefficient
G′3—third order Fourier Coefficient

These tests were done on cryomilled powder.
[1]J. M. Dealy, K. F. Wissbrun, Melt Rheology and Its Role in Plastics Processing: Theory and Applications; edited by Van Nostrand Reinhold, New York (1990)
[2]S. Filipe, Non-Linear Rheology of Polymer Melts, AIP Conference Proceedings 1152, pp. 168-174 (2009)
[3]M. Wilhelm, Macromol. Mat. Eng. 287, 83-105 (2002)
[4]S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010)
[5]S. Filipe, K. Klimke, A. T. Tran, J. Reussner, Proceedings of Novel Non-Linear Rheological Parameters for Molecular Structural Characterisation of Polyolefins, Novel Trends in Rheology IV, Zlin, Check Republik (2011)
[6]K. Klimke, S. Filipe, A. T. Tran, Non-linear rheological parameters for characterization of molecular structural properties in polyolefins, Proceedings of European Polymer Conference, Granada, Spain (2011)

### q) Inorganic Residues

Inorganic residues were measured by TGA according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### EXAMPLES

The feedstock material for IE1 was obtained from a mixed plastic fraction sorted out from municipal solid waste (MSW) from Greece and Poland.

The feedstock material for IE2 was obtained from polyethylene sorted from feedstock of post-consumer waste (PCW) multilayer milk bottles as commercially available on the French and Swiss market.

CE1 is a commercial product of HDPE recyclate. It is based on feedstock of post-consumer waste (PCW) mainly comprising pre-sorted community garbage.

HDPE mix recyclates were obtained for the compositions of IE1 and IE2 by a recycling method comprising the following steps:
a) providing post-consumer plastic waste fractions (as specified above) in bales;
b) screening the material to remove undersize fractions (and on demand oversize fraction),
c) sorting out white and transparent/natural colours (e.g. white bottles, transparent shampoo bottles, yoghurt cups) with a colour sorting step as well as sorting out other polymer types (PP, PS, PA) as well as contaminations such us paper, wood, etc. by near infrared (NIR) and optical sensors.
d) subjecting the remaining fractions consisting of coloured HDPE objects to milling, washing in an alkaline aqueous solution with various detergents and subsequent drying, windsifting and screening;
e) subjecting the resulting plastic flake material to a further sorting for eliminating non-polyolefin flakes;
f) extruding the material and yielding the HDPE blend according to the present invention in the form of pellets.

The properties of the obtained recycled polyethylene mixed color blends are shown in Table 1 below.

TABLE 1

| | IE1 | IE2 | CE1 |
|---|---|---|---|
| Feedstock | PCW (MSW) | PCW (milk bottle) | PCW |
| MFR(190° C./2.16 kg), g/10 min | 0.4 | 0.6 | 0.8 |
| MFR(190° C./5.0 kg), g/10 min | 1.7 | 2.5 | 3.3 |
| MFR(190° C./21.6 kg), g/10 min | 34 | 44 | 65 |
| Density, kg/m³ (ISO-1183) | 961.5 | 980.4 | 955.9 |
| iPP (IR), % | 0.8 | n.d. | 12.1 |
| Heavy metals (XRF), % | 13 ppm | <0.5 ppm | <0.5 ppm |
| Cr | | | |
| Cd | <6 ppm | n.d. | 80 ppm |
| Hg | <0.5 ppm | <0.5 ppm | <0.5 ppm |
| Pb | 10 ppm | <1 ppm | 87.1 ppm |
| Ash content (TGA), wt % | 0.8 | 2.7 | 1.2 |
| C2 fraction (NMR) of soluble | 98.5 | 99.7 | <90 |
| fraction, wt % | | | |
| C4 (NMR) of soluble fraction, | 0.15 | 0.2 | 0.37 |
| wt % | | | |
| C6 (NMR) of soluble fraction, | 0.17 | n.d. | 0.33 |
| wt % | | | |
| C7 and above (NMR) of | n.d. | n.d. | n.d. |
| soluble fraction, wt % | | | |
| isotactic-PP (NMR) of soluble | 1.45 | 0.3 | 22.2 |
| fraction, wt % | | | |
| Crystallinity (calc., DSC), % | 68.4 | 69.1 | |
| Mn (GPC), wt % | 9505 | 12000 | |
| Mw (GPC), wt % | 138500 | 132500 | |
| Mz (GPC), wt % | 826500 | 842500 | |
| MWD (Mw/Mn), GPC | 14.5 | 11 | |
| Soluble fraction at 60° C. | 7.31 | 4.78 | |
| (CFC), % | | | |
| HPF - Homopolymer PE | 81.33 | 84.78 | |
| fraction (HPF) (CFC), wt % | | | |
| CPF - Copolymer PE fraction | 18.67 | 15.22 | |
| (CFC), wt % | | | |
| Odour VDA270-B3 | 3.7 | 3.3 | 4.2 |
| Benzene (HS GC-MS), mg/m³ | below Detection | below Detection | Yes, Benzene |
| | Limit | Limit | detected |
| Limonene (HS GC-MS), | 67 | 3 | |
| mg/m³ | | | |
| LAOS - NLF 1000% 190° C. | 2.3 | 3.9 | 3 |
| Colour CIELAB: | | | |
| L* | 50.1 ± 0.02 | 41.8 ± 0.08 | 37 |
| a* | −2.8 ± 0.02 | −0.5 ± 0.01 | −2 |
| b* | 1.8 ± 0.02 | −3.7 ± 0.01 | 0.8 |
| Eta (0.5 rad/s), Pa · s. | 35295 | 28033 | 30358 |
| Eta (300 rad/s), Pa · s. | 745 | 718 | 597 |
| Shear Thinning Factor (STF), | 47.4 | 39.0 | 50.9 |
| Eta(0.5)/Eta(300) | | | |
| Tensile Modulus, MPa | 872 | 958 | 934 |
| (ISO 527-2, −1A) | | | |
| Charpy Notched Impact | 23.2 | 19.8 | 15.8 |
| Strength (NIS) +23° C., kJ/m² | | | |
| Charpy Notched Impact | 6.5 | 12.3 | 4.3 |
| Strength (NIS) −20° C., kJ/m² | | | |
| Flexural Modulus (ISO 178), | 866 | 980 | 875 |
| MPa | | | |

n.d.—not determinable

Environmental stress cracking resistance according to the FNCT test according to ISO 16770-2019 at 50° C. and 6.0 MPa in 2 wt % Arkopal N100 and impact strength according to the bottle drop test described in the experimental section were conducted with the samples of IE1, IE2 and CE1 described above. The results are shown in Table 2 below.

TABLE 2

| | IE1 | IE2 | CE |
|---|---|---|---|
| FNCT (50° C., 6.0 MPa) - Failure | 11.2 | 3.9 | 3.2 |
| time, hours | | | |
| 1 L bottles drop test - Average drop | 5.2 | 5.3 | 1.1 |
| height at 0° C., meters | | | |
| 1 L bottles drop test - Average drop | 3.4 | 4.7 | 0.7 |
| height at −20° C., meters | | | |

The above results show that the polyethylene mixed color blends according to IE1 and IE2 were improved to a commercial recyclate, in various properties, such as:
(Very) high level of purity for rHDPE mix recyclates (low amount of iPP);
No benzene detected by HS GC-MS;
(Very) low level of contamination from heavy metals (Cr, Cd, Pb, Hg);
Good toughness performance, even at low temperature (Charpy notched impact strength);
Good mechanical performance of the bottles (e.g. bottle drop test).
Better resistance against Environmental Stress Cracking (FNCT).

The improvement of chemical purity is shown by IE1 having an iPP content of only 0.8 wt.-%, whereas the conventional recyclate according to CE1 showed an impurity of 12.1 wt.-%. At the same time both examples IE1 and IE2 showed reduced levels of heavy metals and benzene contents below the detection limit, which requirements are not fulfilled for CE1.

The mixed color blends according to IE1 and IE2 were further improved over the blend of CE1 in mechanical performance. Both inventive examples showed superior Charpy notched impact strength (Table 1), superior ESCR (FNCT) and toughness in the bottle drop test (Table 2).

1. A polyethylene mixed color blend obtained from post-consumer recyclates (PCR), said polyethylene mixed color blend having
(i) a melt flow rate (ISO1133, 5.0 kg; 190° C.) of 0.1 to 10 g/10 min,
(ii) a density of 950 to 990 kg/m³ (ISO1183);
(iii) a C2 fraction in an amount of at least 95.0 wt.-%, as measured by ¹³C-NMR of the d2-tetrachloroethylene soluble fraction;
(iv) a homopolymer fraction (HPF) content determined according to Chemical Composition Analysis by Cross Fractionation Chromatography (CFC), as described herein, in the range from 73.0 to 91.0 wt.-%; and
(v) a copolymer fraction (CPF) content determined according to Chemical Composition Analysis Cross Fractionation Chromatography (CFC), as described herein, in the range from 10.0 to 22.0 wt.-%;
(vi) a total content of heavy metals selected from Cr, Cd, Hg and Pb of not more than 100 ppm with respect to the total polyethylene blend, as measured by x-ray fluorescence (XRF) as described herein; and
(vii) a Full Notch Creep Test (FNCT), determined according to ISO 16770-2019, at 50° C. and 6.0 MPa in 2 wt.-% Arkopal N100, as described herein, of at least 3.0 h time to failure,
the polyethylene mixed color blend having a CIELAB color space (L*a*b*) measured according to DIN EN ISO 11664-4, as described herein, of
L* from 30.0 to 73.0;
a* from −10 to 25;
b* from −5 to 20.

2. The polyethylene mixed color blend according to claim 1, having units originating from isotactic polypropylene (iPP) in an amount of from 0.1 to 3.0 wt. %, determined by ¹³C-NMR analysis of the soluble fraction, as described herein.

3. The polyethylene mixed color blend according to claim 1 having a Large Amplitude Oscillatory Shear-Non-Linear Factor (LAOS-NLF), determined at 190° C., an angular frequency of 0.628 rad/s and a strain of 1000%, as described herein
$$LAOS - NLF = \vert \frac{{G}_{1}^{′}}{{G}_{3}^{′}} \vert$$
whereby
G₁′ is the first order Fourier Coefficient
G₃′ is the third order Fourier Coefficent
in the range of 2.0 to 4.0.

4. The polyethylene mixed color blend according to claim 1 having a shear thinning factor (STF) value, defined as the ratio of the complex viscosities eta(0.05) and eta(300) at 190° C. within a frequency range of from 0.01 and 600 rad/s according to ISO 6721-1 and 6721-10, determined as described herein, in the range of from 30 to 60.

5. The polyethylene mixed color blend according to claim 1 having a benzene content below the detection limit, determined according to static headspace chromatography mass spectroscopy (HS/GC-MS) at 100° C./2 h, as described herein.

6. The polyethylene mixed color blend according to claim 1 having a Charpy notched impact strength, determined according to ISO 179-1 eA at −20° C. on injection moulded specimens of 80×10×4 mm prepared according to EN ISO 1873-2, of at least 5.0 kJ/m².

7. The polyethylene mixed color blend according to claim 1 having an impact strength in a 1 L bottle drop test, as described herein at 0° C., of at least 3.0 m average drop height, wherein the bottles were produced as described herein.

8. A method of recycling a polyethylene mixed color material, comprising the steps of:
a) providing a mixed plastic waste stream (A);
b) sieving the mixed plastic waste stream (A) to create a sieved mixed plastic waste stream (B) having only articles with a longest dimension in the range from 30 to 400 mm;
c) sorting the sieved mixed plastic waste stream (B) by means of one or more sorting systems equipped with near infrared (NIR) and optical sensors, wherein the sieved mixed plastic waste stream (B) is at least sorted by polymer type and color, and optionally article form, thereby generating a sorted mixed-color polyethylene recycling stream (CM) that is subjected separately to steps d) and beyond;
d) shredding the sorted mixed-color polyethylene recycling stream (CM) to form a flaked mixed-color polyethylene recycling stream (D);
e) washing the flaked mixed-color polyethylene recycling stream (D) with a first aqueous washing solution (W1) without the input of thermal energy, thereby generating a first suspended polyethylene recycling stream (E);
f) removing at least a part of the first aqueous washing solution (W1) from the first suspended polyethylene recycling stream (E) to obtain a first washed polyethylene recycling stream (F);
g) washing the first washed polyethylene recycling stream (F) with a second aqueous washing solution (W2) thereby generating a second suspended polyethylene recycling stream (G), wherein sufficient thermal energy is introduced to the second suspended polyethylene recycling stream (G) to provide a temperature in the range from 65 to 95° C. during the washing;
h) removing the second aqueous washing solution (W2) and any material not floating on the surface of the second aqueous washing solution (W2) from the second suspended polyethylene recycling stream (G) to obtain a second washed polyethylene recycling stream (H);
i) drying the second washed polyethylene recycling stream (H), thereby obtaining a dried polyethylene recycling stream (I), which contains the polyethylene mixed color blend according to any one of the preceding claims; and
j) separating the dried polyethylene recycling stream (I) obtained from step i) into a light fraction and a heavy fraction polyethylene recycling stream (J).

9. (canceled)

10. (canceled)

11. Article made from the polyethylene mixed color blend according to claim 1, wherein the polyethylene mixed color blend amounts to at least 85 wt. % of the total composition for making the article.

12. Article according to claim 11 being a bottle.

13. Blend containing the polyethylene mixed color blend according to claim 1 and at least one virgin polyolefin and/or recycled polyolefin.

14. (canceled)

15. The blend of claim 1, wherein in step 1), additives (Ad) are added in the melt state to form the extruded, pelletized, recycled polyethylene product (L).

16. The blend of claim 1, wherein additives (Ad) are added in the melt state to the purified polyethylene recycling stream (K) to form the extruded, pelletized, recycled polyethylene product (M3).

17. The blend of claim 1, wherein the extruded, pelletized, recycled polyethylene product (M3) is aerated.

18. A method for using the polyethylene mixed color blend of claim 1, comprising forming a package, a rotomolded product, an automotive part, a wire, or a cable from the polyethylene mixed color blend.

19. A method for using the blend of claim 13, comprising forming a package, a rotomolded product, an automotive part, a wire, or a cable from the blend.

20. The method of claim 8, further comprising at least one of the following steps:
k) further sorting the heavy fraction polyethylene recycling stream (J) or, in the case that step j) is absent, the dried polyethylene recycling stream (I) by means of one or more optical sorters sorting for one or more target polyethylenes by removing any flakes containing material other than the one or more target polyethylenes, yielding a purified polyethylene recycling stream (K);
l) melt extruding and pelletizing the purified polyethylene recycling stream (K) to form an extruded, pelletized, recycled polyethylene product (L); and
m) optionally aerating the recycled polyethylene product (L) to remove volatile organic compounds, thereby generating an aerated recycled polyethylene product (M), being either an aerated extruded, pelletized, recycled polyethylene product (M1) or aerated recycled polyethylene flakes (M2),
wherein the order of steps l) and m), if present, can be interchanged, such that the purified polyethylene recycling stream (K) is first aerated to form aerated recycled polyethylene flakes (M2) that are subsequently extruded to form an extruded, pelletized, recycled polyethylene product (M3), which is the polyethylene mixed color blend.
